(19) United States
(12) Patent Application Publication
(10) Pub. No.: US 2026/0136223 A1
(43) Pub. Date: May 14, 2026

(54) LINK-BASED ADAPTATION OF SYNCHRONIZATION SIGNAL PHYSICAL BROADCAST CHANNEL BLOCK MEASUREMENT TIMING CONFIGURATION SHARING

(71) Applicants: Nokia Technologies Oy, Espoo (FI); NOKIA OF AMERICA CORPORATION, Murray Hill, NJ (US)

(72) Inventors: Rafael CAUDURO DIAS DE PAIVA, Aalborg (DK); Erika PORTELA LOPES DE ALMEIDA, Aalborg (DK); Lars DALSGAARD, Oulu (FI); Samantha CAPORAL DEL BARRIO, Aalborg (DK)

(21) Appl. No.: 19/118,636

(22) PCT Filed: Oct. 10, 2022
(86) PCT No.: PCT/US2022/046175

§ 371 Date: Apr. 4, 2025

(51) Int. Cl. H04W 24/10

(52) U.S. Cl. CPC H04W 24/10

(57) ABSTRACT

Systems, methods, apparatuses, and computer program products for providing scheduling flexibility between transmission configuration indicator states for data reception and RRM measurements for multi-Rx chain UE. One method may include transmitting, to a network entity, a measurement timing configuration; and receiving a sharing factor associated with the measurement timing configuration. The sharing factor indicates a sharing pattern associated with a first spatial receive element performing radio resource management measurements, and a second spatial receive element configured to receive data without scheduling restrictions.

### TECHNICAL FIELD

Some example embodiments may generally relate to mobile or wireless telecommunication systems, such as 3^{rd} Generation Partnership Project (3GPP) Long Term Evolution (LTE), 5^{th} generation (5G) radio access technology (RAT), new radio (NR) access technology, 6^{th} generation (6G), and/or other communications systems. For example, certain example embodiments may relate to systems and/or methods for providing scheduling flexibility between transmission configuration indicator (TCI) states for data reception and radio resource management (RRM) measurements for multi-receiver (Rx) chain user equipment (UE).

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the radio access network (RAN) for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include transmitting, to a network entity, a measurement timing configuration. The method may further include receiving a sharing factor associated with the measurement timing configuration. The sharing factor may indicate a sharing pattern associated with a first receive element performing radio resource management measurements, and a second receive element configured to receive data without scheduling restrictions.

In accordance with certain example embodiments, an apparatus may include means for transmitting, to a network entity, a measurement timing configuration. The apparatus may further include means for receiving a sharing factor associated with the measurement timing configuration. The sharing factor may indicate a sharing pattern associated with a first receive element performing radio resource management measurements, and a second receive element configured to receive data without scheduling restrictions.

In accordance with various example embodiments, a non-transitory computer readable medium may include program instructions that, when executed by an apparatus, cause the apparatus to perform at least a method. The method may include transmitting, to a network entity, a measurement timing configuration. The method may further include receiving a sharing factor associated with the measurement timing configuration. The sharing factor may indicate a sharing pattern associated with a first receive element performing radio resource management measurements, and a second receive element configured to receive data without scheduling restrictions.

In accordance with some example embodiments, a computer program product may perform a method. The method may include transmitting, to a network entity, a measurement timing configuration. The method may further include receiving a sharing factor associated with the measurement timing configuration. The sharing factor may indicate a sharing pattern associated with a first receive element performing radio resource management measurements, and a second receive element configured to receive data without scheduling restrictions.

In accordance with certain example embodiments, an apparatus may include at least one processor and at least one memory storing instructions that, when executed by the at least one processor, cause the apparatus at least to transmit, to a network entity, a measurement timing configuration. The at least one memory and instructions, when executed by the at least one processor, may further cause the apparatus at least to receive a sharing factor associated with the measurement timing configuration. The sharing factor may indicate a sharing pattern associated with a first receive element performing radio resource management measurements, and a second receive element configured to receive data without scheduling restrictions.

In accordance with various example embodiments, an apparatus may include transmitting circuitry configured to transmit, to a network entity, a measurement timing configuration. The apparatus may further include receiving circuitry configured to receive a sharing factor associated with the measurement timing configuration. The sharing factor may indicate a sharing pattern associated with a first receive element performing radio resource management measurements, and a second receive element configured to receive data without scheduling restrictions.

In accordance with some example embodiments, a method may include transmitting, to a user equipment, a measurement timing configuration. The method may further include transmitting a sharing factor associated with the measurement timing configuration. The sharing factor may indicate a sharing pattern associated with a first receive element performing radio resource management measurements, and a second receive element configured to receive data without scheduling restrictions.

In accordance with certain example embodiments, an apparatus may include means for transmitting, to a user equipment, a measurement timing configuration. The apparatus may further include means for transmitting a sharing factor associated with the measurement timing configuration. The sharing factor may indicate a sharing pattern associated with a first receive element performing radio resource management measurements, and a second receive element configured to receive data without scheduling restrictions.

In accordance with various example embodiments, a non-transitory computer readable medium may include program instructions that, when executed by an apparatus, cause the apparatus to perform at least a method. The method may include transmitting, to a user equipment, a measurement timing configuration. The method may further include transmitting a sharing factor associated with the measurement timing configuration. The sharing factor may indicate a sharing pattern associated with a first receive element performing radio resource management measurements, and a second receive element configured to receive data without scheduling restrictions.

In accordance with some example embodiments, a computer program product may perform a method. The method may include transmitting, to a user equipment, a measurement timing configuration. The method may further include transmitting a sharing factor associated with the measurement timing configuration. The sharing factor may indicate a sharing pattern associated with a first receive element performing radio resource management measurements, and a second receive element configured to receive data without scheduling restrictions.

In accordance with certain example embodiments, an apparatus may include at least one processor and at least one memory storing instructions that, when executed by the at least one processor, cause the apparatus at least to transmit, to a user equipment, a measurement timing configuration. The at least one memory and instructions, when executed by the at least one processor, may further cause the apparatus at least to transmit a sharing factor associated with the measurement timing configuration. The sharing factor may indicate a sharing pattern associated with a first receive element performing radio resource management measurements, and a second receive element configured to receive data without scheduling restrictions.

In accordance with various example embodiments, an apparatus may include first transmitting circuitry configured to transmit, to a user equipment, a measurement timing configuration. The apparatus may further include second transmitting circuitry configured to transmit a sharing factor associated with the measurement timing configuration. The sharing factor may indicate a sharing pattern associated with a first receive element performing radio resource management measurements, and a second receive element configured to receive data without scheduling restrictions.

### BRIEF DESCRIPTION OF THE DRAWINGS

For a proper understanding of example embodiments, reference should be made to the accompanying drawings, wherein:

FIG. 1 illustrates an example of a single-Rx chain UE operation;

FIG. 2 illustrates an example of a multi-Rx chain UE;

FIG. 3A illustrates an example of 2-Rx chains per panel UE architecture;

FIG. 3B illustrates an example of a 4-Rx chains per panel UE architecture;

FIG. 4 illustrates an example of a narrow and rough beam pattern;

FIG. 5 illustrates an example of scheduling restrictions for a slot with a 120 kHz subcarrier spacing synchronization signal block pattern considering 120 kHz subcarrier spacing for physical downlink shared channel;

FIG. 6A illustrates an example for multi-Rx downlink receptions, wherein the UE is able to receive two downlink streams and achieve 4 layer multiple input multiple output;

FIG. 6B illustrates another example for multi-Rx downlink receptions, wherein the UE is able to receive two downlink streams and achieve 4 layer multiple input multiple output;

FIG. 6C illustrates an example for multi-Rx downlink receptions, wherein the UE is able to receive data in one of its Rx chains while using another Rx chain to perform RRM measurements;

FIG. 7 illustrates some challenges addressed by some certain embodiments described herein;

FIG. 8 illustrates some example embodiments described herein;

FIGS. 9A-H illustrate examples of panel, beam, and Rx chain usage for each synchronization signal physical broadcast channel block measurement timing configuration occasion;

FIG. 10 illustrates an example of a signaling diagram according to certain example embodiments;

FIG. 11 illustrates an example of another signaling diagram according to some example embodiments;

FIG. 12 illustrates an example of another signaling diagram according to various example embodiments;

FIG. 13 illustrates an example of a flow diagram of a method according to certain example embodiments;

FIG. 14 illustrates an example of a flow diagram of a method according to some example embodiments;

FIG. 15 illustrates an example of a flow diagram of a method according to various example embodiments;

FIG. 16 illustrates an example of a flow diagram of a method according to certain example embodiments;

FIG. 17 illustrates an example of a flow diagram of a method according to some example embodiments;

FIG. 18 illustrates an example of a flow diagram of a method according to various example embodiments;

FIG. 19 illustrates an example of various network devices according to certain example embodiments; and

FIG. 20 illustrates an example of a 5G network and system architecture according to some example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing scheduling flexibility between TCI states for data reception and RRM measurements is not intended to limit the scope of certain example embodiments, but is instead representative of selected example embodiments.

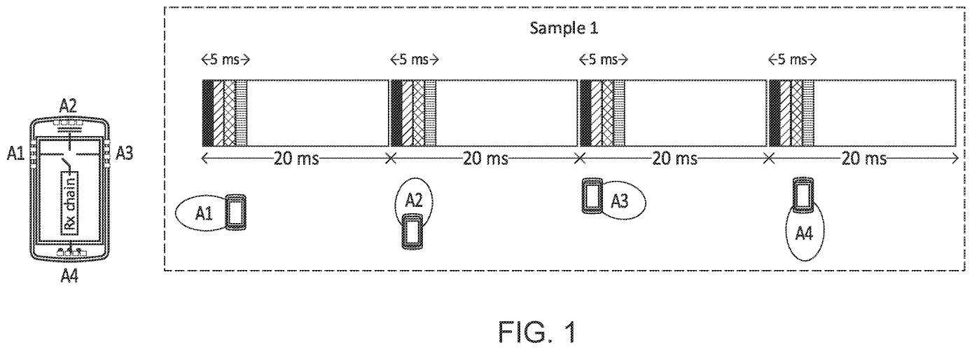

Frequency range (FR)2 antenna arrays on UEs are assumed to be directional; thus, in order to perform well, UEs may have one or more antenna panels embedded. Nevertheless, a 1-to-1 mapping is not required between the number of antenna panels and the number of Rx chains on the UE. As such, 3GPP Release (Rel)-17 FR2 RAN4 requirements assume a single-chain UE, wherein the Rel-17 UEs (and earlier) can fulfill RAN4 requirements, assuming and only requiring single Rx chains being active. Hence, only a single active FR2 panel/Rx chain at the time is required. This behavior can simplify UE implementation, especially for early implementations without limiting the UE implementation. However, this also introduces a disadvantage with neighbor cell measurements since a single Rx reception assumption means that the UE must sweep its reception over its panels, one Rx at the time. The UE must sweep its reception in order to survey its environment (i.e., spherical coverage) t times (i.e., sweep delay). As an example, FIG. 1 illustrates a single-chain, 4-panel Rx UE that requires 4 consecutive Rx sweeps/bursts for a single sample, full spherical measurement acquisition. In addition, 3-5 samples per Rx sweep/burst direction may be needed for each Rx spatial setting for layer (L)1 and/or L3 measurements to ensure accuracy of the UE cell detection and/or measurements. As shown in FIG. 1, the UE may use the synchronization signal block (SSB) burst for cell detection and measurements. The gNB may transmit each SSB burst once per 20 ms; with 1 Rx active at a time on UE side, the UE may sample in one direction once per SSB burst.

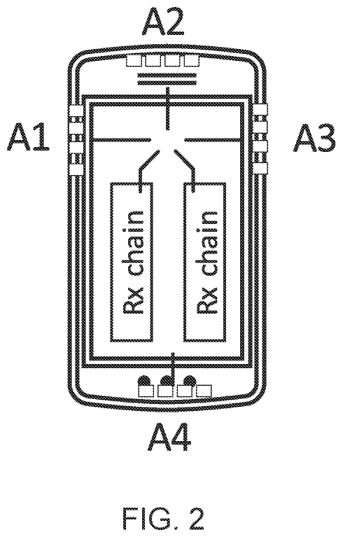

FIG. 2 depicts an example of a possible multi-Rx chain UE implementation, which may improve UE and system level performance (e.g., measurement related latencies). As shown in FIG. 2, 4 antenna panels are implemented in the UE (A1-A4), which are arranged to improve spherical coverage, and 2 Rx chains are used. The two Rx chains in FIG. 2 may be switched between the four panels, such that any two-panel combination may be active at a time.

When considering FIG. 2, it may be possible for a UE in some UE implementations to perform measurements (e.g., RRM measurements) using more than 1 Rx chain at the same time. In other UE implementations, the UE may receive and perform RRM measurements using one Rx chain, while receiving data using other Rx chain.

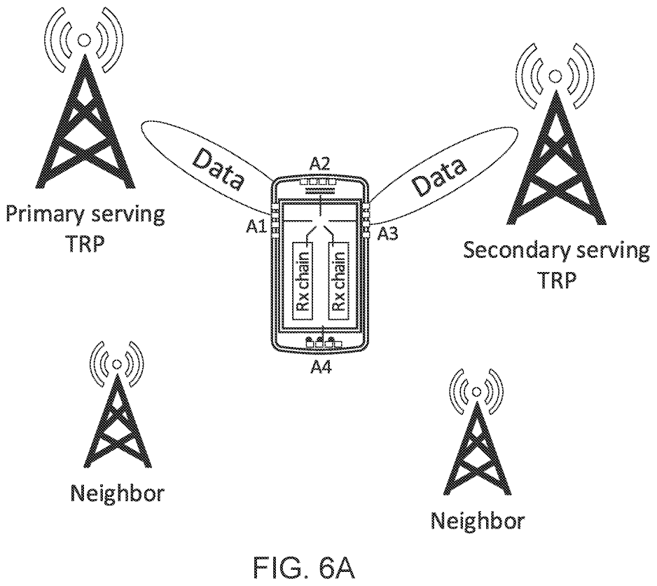

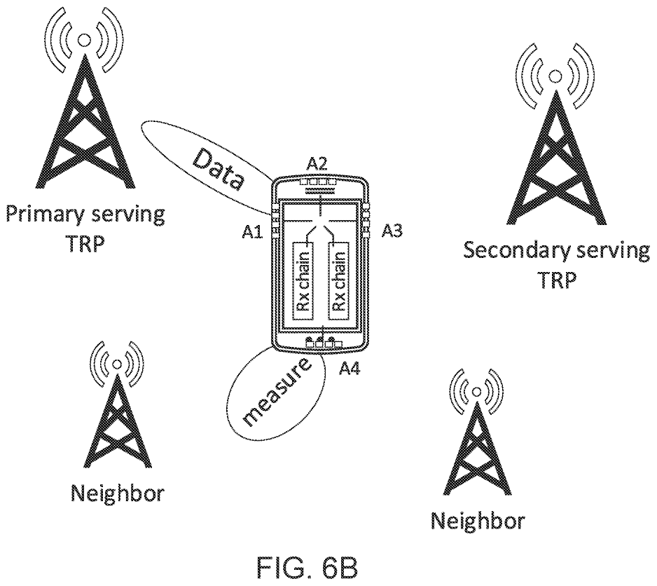

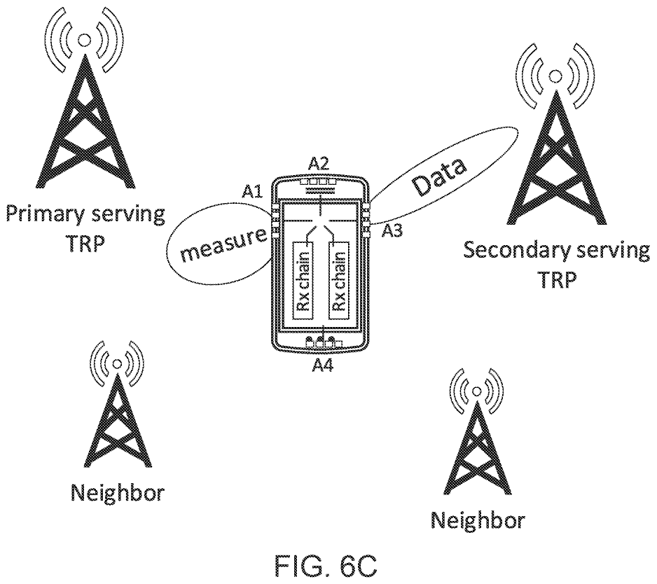

In a normal downlink (DL) data reception scenario, multi Rx UE may receive on 2 data chains, potentially from different transmission reception points (TRPs), as illustrated in FIG. 6A where a UE is shown using two Rx chains to receive data using 2 different Rx chains/panels from 2 different TRPs. In this scenario, it may be possible for the UE to receive 4 layer DL multiple input multiple output (MIMO), since in FR2, each panel may use cross-polarized antennas in order to achieve 2 layers; as a result, when combining 2 panels, 4 layers can be achieved. Although this example uses TRP as the source of transmission, any transmission sources may be used, such as remote radio head (RRH), cells, and gNB.

Although 4 layer DL MIMO may be possible with multiple Rx chains in the UE, the UE may be unable to use both Rx chains to receive data in 4 layers while performing RRM measurements. Typically, in FR2, L3 RRM measurements may be performed with different spatial Rx settings in the UE (e.g., rough beams) than used for, as an example, data reception and transmission, as well as L1 measurements (e.g., refined beams). In particular, in some common implementations, a broad beam may be associated with each UE panel for L3 measurements, and no beam refinement may be applied; Rx sweeping may be expected and even necessary when conducting such measurements. A beam sweeping scaling factor may be specified for FR2-1 (e.g., for cell detection and measurements). With the architecture shown in FIG. 2, it is possible for some of the UEs to use 1 or 2 rough beams simultaneously (i.e., 1 per Rx chain) when sweeping over the entire UE spherical coverage area.

As part of the multi-Rx discussion in 3GPP RAN4, with a single Rx chain, the UE cannot perform DL demodulation and RRM measurements tasks simultaneously. Nevertheless, each of the two Rx chains may perform different tasks independently. Hence, some UE may be able to receive data with one active Rx chain, and perform measurements with the other Rx chain. Other implementations may enable UEs to measure with two Rx chains simultaneously, while in other implementations, the UE may be unable to perform measurements and data reception simultaneously.

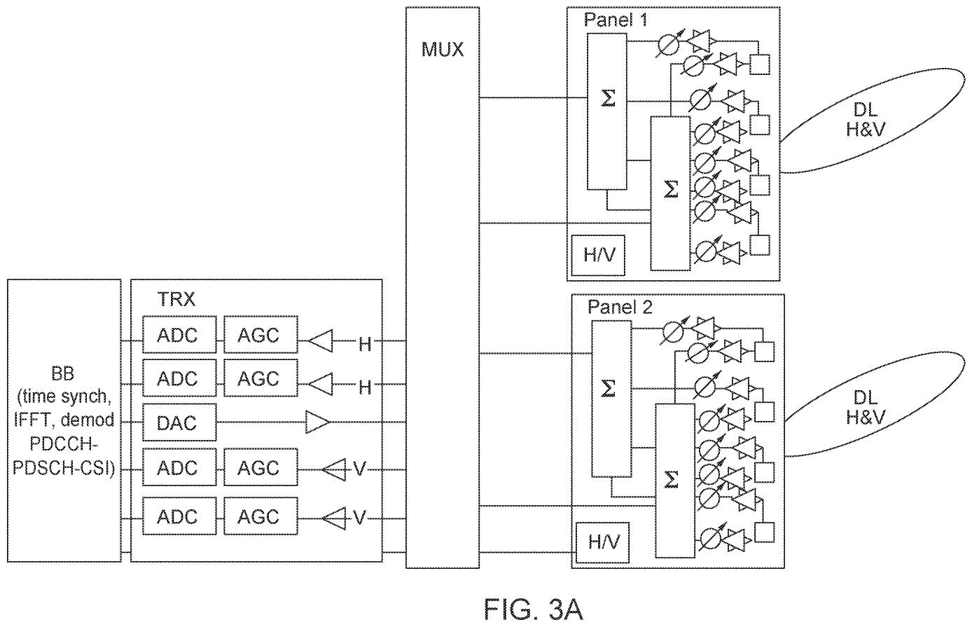

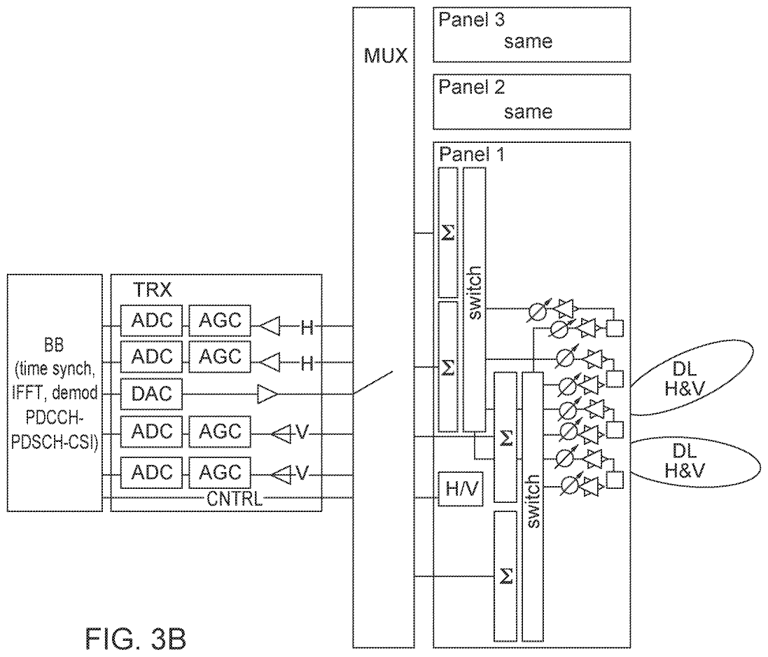

FIGS. 3A-B depict two possible UE panel architecture examples. In particular, FIG. 3A illustrates an example of a 2 Rx chains per panel UE architecture, while FIG. 3B illustrates an example of a 4 Rx chains per panel UE architecture. As part of the multi Rx discussion, some UE architectures may be unable to use 2 Rx chains from the same panel, indicating that a minimum angle separation must exist from the beams used for each of the Rx chains. This minimum separation may affect which beams the UE can simultaneously use for data and RRM measurements. As a result, narrow beams used for data may need to be turned off whenever the UE needs to perform RRM measurements on a similar direction than that of the data beam.

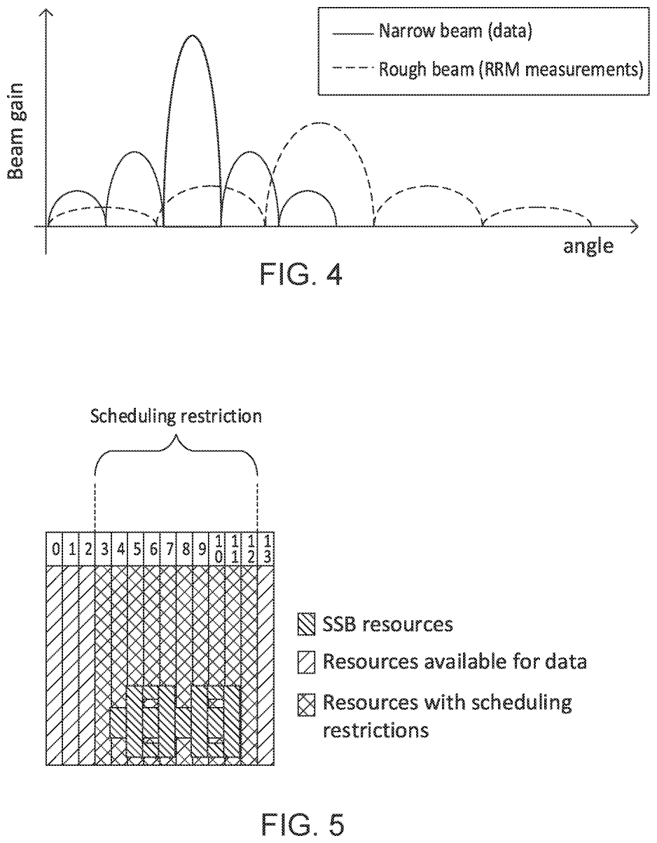

FIG. 4 depicts a narrow beam that may be used for data, and a rough beam used for RRM measurements. Since the rough beam typically uses fewer antenna elements, it may also have a smaller beamforming gain compared to the narrow beam in order to have a wider beam width and detect neighbor cells more effectively.

As part of the 3GPP Rel-15 to Rel-17 RRM requirements, scheduling restrictions may apply when the UE performs RRM measurements. For example, FIG. 5 shows an example of such restrictions when considering 120 kHz subcarrier spacing (SCS) numerology (i.e., SSB and physical downlink shared channel (PDSCH) using 120 kHz SCS). In this example, one symbol before and after the SSB symbols may be unavailable for the UE to be scheduled, since with one Rx, the UE may change the special filter parameters while performing RRM measurements in other directions. In that scenario, only 4 out of 14 symbols may be available for scheduling. If the synchronization signal physical broadcast channel block measurement timing configuration (SMTC) window is a maximum of 5 ms, and if all SSB positions are used inside the SMTC window, only 28% of the time resources may be available during that window. Additionally, since the SMTC may be the same for several UEs in the network, most of the UEs may be restricted to the same symbols, leaving few resources for the network to schedule UEs. As a result, these restrictions may significantly hinder network performance.

In light of the restrictions above, and regardless of the architecture chosen for UE implementation, whenever RRM measurements need to be performed, a UE may need to change Rx settings to perform RRM measurements. Similarly, for a multi Rx UE, the UE may need to switch at least one of its receiver chains from DL data reception mode to RRM measurement mode when performing measurements. This is illustrated in FIGS. 6A-C, where the UE switches its mode of operation (i.e., change spatial Rx settings). In FIG. 6A, the UE has 2 beams dedicated for data reception by configuring 2 active TCI states, which may connect the UE to different non-collocated TRPs. In FIG. 6B, the UE may maintain one of its Rx chains in DL demodulation (i.e., data Rx) mode, such that the data from one TRP (e.g., primary serving TRP) may be received while performing measurements using the second receiver chain. Hence, the UE may perform measurements (e.g., sweeping) using the second Rx chain using panels A2-A4. When the UE needs to perform measurements on the direction covered by panel A1, the UE may switch to the spatial Rx configuration on panel A1, as shown in FIG. 6C.

However, challenges remain with scheduling optimization when a multi Rx chain UE performs measurements, where the UE may achieve performance gains when scheduling restrictions are not needed while performing measurements. Whenever the UE performs RRM measurements (e.g., intra-frequency measurements), the symbols before and after, and on which, it is measuring (e.g., SSB symbols) may have scheduling restrictions; thus, the gNB may be unable to assume that the UE can receive or transmit any data during those symbols. However, when multi Rx chain UEs are considered, the scheduling restrictions may be optimized (or even completely removed) to enable simultaneous L3 and data operations. However, 4 layer MIMO throughput may be difficult to maintain during those measurements.

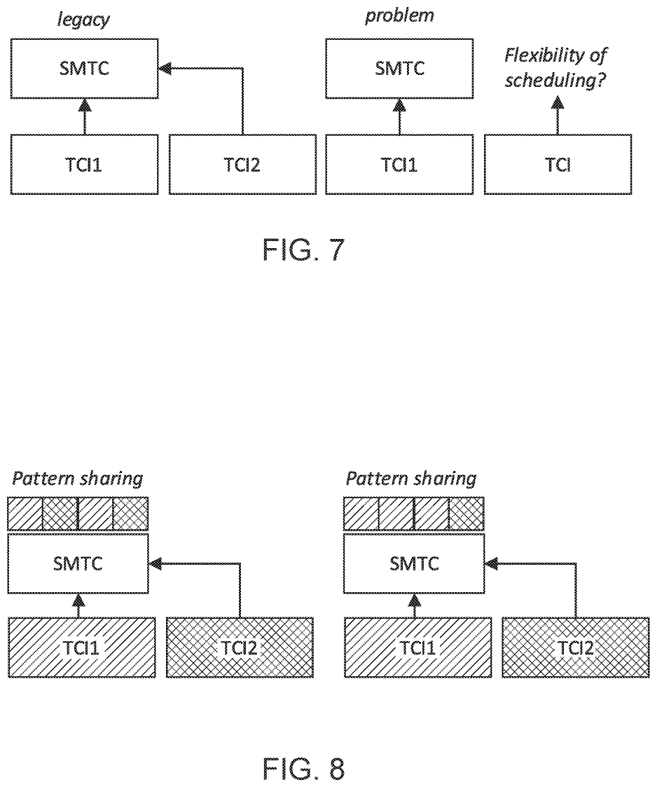

Thus, it may be beneficial to enhance multi Rx operations with reduced scheduling restrictions such that throughput is maximized during RRM measurements, and that adaptation with UE movement/rotation is possible. Furthermore, if signal-to-noise ratio (SNR) and maximum achievable throughput differ from the primary and secondary serving TRPs shown in FIG. 6, when maintaining one data link during L3 measurements, the TRP with the best SNR/throughput may be used for the maximum amount of time, while the other TRP may be used to perform measurements. Scheduling restrictions from legacy solutions may be applied to the UE (e.g., both TCI states), and there is currently no differentiation between the TCI states depicted in FIG. 7. Although various example embodiments described herein use primary and secondary TRPs, any transmission sources may be used.

Certain example embodiments described herein may have various benefits and/or advantages to overcome the disadvantages described above. For example, certain example embodiments may minimize the amount of time that a UE cannot receive data and the resulting impact to throughput due to scheduling restrictions. Thus, certain example embodiments discussed below are directed to improvements in computer-related technology.

Using the architecture of FIG. 8, certain example embodiments described below may balance scheduling restrictions during RRM measurements when considering a multiple Rx chain capable UE, thereby enabling a UE to receive with more than one Rx chain simultaneously. In particular, the UE and gNB may exchange information that allows them to leverage the impact from RRM measurements in terms of scheduling and restrictions by determining when a particular Rx chain is used (e.g., an Rx chain associated with a given TCI state is interrupted or scheduling restricted due to the performing RRM measurements). Some example embodiments may consider the link quality of the data streams for the individual Rx chains, each of which may be associated with a TCI state in order to determine which Rx chain (or TCI state) would experience the worst impact from scheduling restrictions. Furthermore, association an of the scheduling restriction/interruption pattern to each Rx chain/TCI state may be defined. A restriction pattern may also be defined and applied for each of the TCI states of the UE, enabling the gNB to know when the UE is available for scheduling in each of the TCI states.

According to some example embodiments, a channel quality aware measurement method that accounts for the scheduling restrictions may minimize the use of the Rx chain on which the UE experiences better channel conditions or performance metrics (which may be reflected in overall throughput) to perform measurements. Hence, fewer scheduling restrictions/interruptions may occur for that Rx chain. The UE may use the Rx chain which has the worst performance metrics for performing a larger number of measurements, and as a result, that Rx chain may experience more scheduling restrictions/interruptions.

In various example embodiments, the UE may be configured with a TCI-based (or TCI specific) SMTC sharing or usage factor. In one example, the usage factor may be implemented such that on a cycle of N+M SMTC occasions, the first M SMTC occasions have no scheduling restrictions for TCI state #1 (TCI #1), and N SMTC occasions have no scheduling restrictions for TCI state #2 (TCI #2). If M+N is always 2, 4, or 8, it may be possible to define TCI scheduling sharing factors of 12.5%/82.5% (e.g., N=7, M=1), 25%/75% (e.g., N=3, M=1), or 50%/50% (e.g., equal share N=M=1).

In order to determine which TCI state would or would not have scheduling restrictions for a given SMTC occasion, the system frame number (SFN) may be used as a reference. Since the SFN may have a time reference of 10 ms, and the SMTC may have a T_{SMTC} (i.e., periodicity of the SMTC occasion configured for the intra-frequency and/or inter-frequency carrier i) from 5 ms to 160 ms, with an offset in the same range, the reference index for the SMTC occasion may be determined using the first SFN from the SMTC window as

$${I}_{SMTC} = \frac{SFN * 10 ms}{{T}_{SMTC}} .$$

Based on the SMTC index (I_{SMTC}), it may be possible to use a rule to determine which SMTC occasions have scheduling restrictions related to TCI #1 and TCI #2. For example, if mod (I_{SMTC}, N+M)<M, scheduling restrictions may apply for TCI #2, and TCI #1 may have no scheduling restrictions. Alternatively, scheduling restrictions may apply for TCI #1, while TCI #2 may have no scheduling restrictions.

In order to perform the described techniques above, triggers for activating each configuration may need to be defined. These triggers may be done with explicit signalling (e.g., RRC or medium access control (MAC) signalling where either the UE or the gNB indicates the preferred mode), and/or by reusing events such as measurement reports. The trigger for the change in configuration may provide the gNB with information required for scheduling; thus, it should be clear for the gNB when the UE is active on a given TCI state and has no scheduling restrictions, and when another TCI state is interrupted or scheduling restricted due to performing measurements.

In certain example embodiments, measurement reports that are reported per DL beam or per TCI (e.g., L1-reference signal received power (RSRP) measurement reports) may be used as a trigger for changing the per TCI (or Rx chain) scheduling restriction patterns due to RRM measurements. Specifically, the UE may perform (and possibly send) L1-RSRP reports; when the difference in RSRP for an active TCI state is a threshold larger than the RSRP of the other active TCI state/Rx chain, the SMTC sharing factor may change without additional signalling. In an alternative example embodiment, the change may be facilitated by signalling (e.g., network indicates to the UE any change of sharing factor).

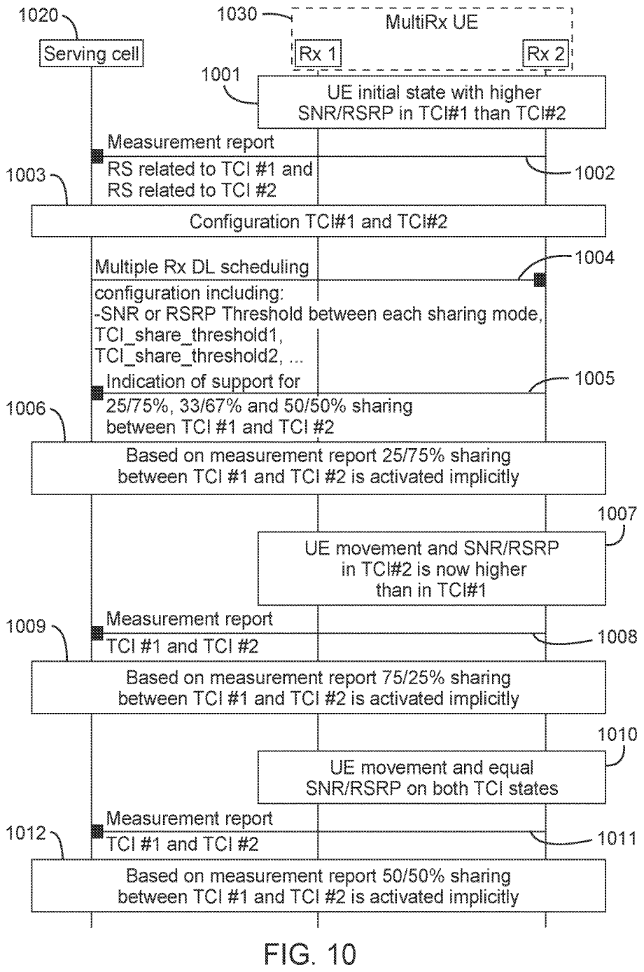

In some example embodiments, the network may configure thresholds for different measurement shares for the TCI states. For example, TCI_share_threshold1 may define when an equal share is used for both TCI states, TCI_share_threshold2 may define when a 25%/75% share is to be used, and TCI_share_threshold3 may define when a 12.5%/87.5% share is to be used. Measurement reports may include any of L3 measurement reports, L1 measurement reports, RSRP reports, channel state information (CSI) reports, or any other UE-assisted measurement report. Various example embodiments may use metrics besides RSRP, for example, based on a data performance throughput metric either alone or in combination to the RSRP metric. FIG. 10 (discussed in more detail below) depicts a signalling diagram implementing this trigger alternative. In this example embodiment, the UE may indicate the sharing patterns that it supports to the gNB, which may be signaled as part of UE assistance information. The pattern may also be linked to the architecture of the UE. For example, some UEs may use 3 panels with 2 rough beams on each, meaning that the sharing pattern may optimally include multiples of 3, but not multiples of 4.

In certain example embodiments, the gNB may signal to the UE (via RRC or MAC control element (CE)) the sharing configuration to be used. In response, the gNB may use any network specific information (e.g., packet loss), as well as the UE reports, to determine the best sharing configuration.

In some example embodiments, the UE may monitor link quality for TCI #1 and TCI #2, and may indicate to the gNB the preferred share for the RRM measurements. The indication may be transmitted by UE assistance information, and in response, the gNB may confirm which configuration is to be used.

Various example embodiments may use predefined scheduling restriction sharing patterns. For example, the restriction sharing patterns shown in Table 1 below consider equal sharing of the scheduling restrictions on the active Rx chains among the SMTC occasions.

TABLE 1
Multi Rx scheduling restriction pattern with equal sharing between Rx1 and Rx2

| | SMTC # | 0 | 1 | 2 | 3 | 4 | 5 | 6 | 7 | 8 | 9 | 10 | 11 |
|---|---|---|---|---|---|---|---|---|---|---|---|---|---|
| TCI#1 | DL Rx | x | | x | | x | | x | | x | | x | |
| | RS measurements | | x | | x | | x | | x | | x | | x |
| TCI#2 | DL Rx | | x | | x | | x | | x | | x | | x |
| | RS measurements | x | | x | | x | | x | | x | | x | |

Similarly, in Table 2 below, 1 out of 4 SMTC occasions have scheduling restrictions on the Rx chain related to TCI #2, but not on the Rx chain related/associated to TCI #1, implying 25/75% sharing.

TABLE 2
Multi Rx scheduling restriction pattern
with 25/75% sharing between Rx1 and Rx2

| | SMTC # | 0 | 1 | 2 | 3 | 4 | 5 | 6 | 7 | 8 | 9 | 10 | 11 |
|---|---|---|---|---|---|---|---|---|---|---|---|---|---|
| TCI#1 | DL Rx | x | x | x | | x | x | x | | x | x | x | |
| | RS measurements | | | | x | | | | x | | | | x |
| TCI#2 | DL Rx | | | | x | | | | x | | | | x |
| | RS measurements | x | x | x | | x | x | x | | x | x | x | |

In the example of Table 3, 1 out of 3 SMTC occasions have scheduling restrictions on the Rx chain related/associated with TCI #2, but not on the Rx chain related/associated with TCI #1, implying 33.4/66.6% sharing.

TABLE 3
Multi Rx scheduling restriction pattern with
33.3/66.7% sharing between Rx1 and Rx2

| | SMTC # | 0 | 1 | 2 | 3 | 4 | 6 | 7 | 8 | 9 | 10 | 11 | 12 |
|---|---|---|---|---|---|---|---|---|---|---|---|---|---|
| TCI#1 | DL Rx | x | x | | x | x | | x | x | | x | x | |
| | RS measurements | | | x | | | x | | | x | | | x |
| TCI#2 | DL Rx | | | x | | | x | | | x | | | x |
| | RS measurements | x | x | | x | x | | x | x | | x | x | |

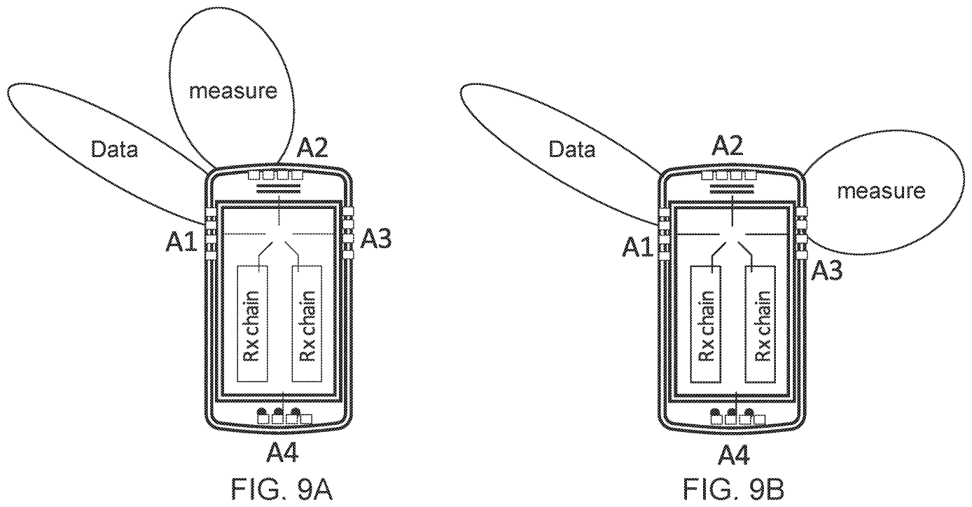

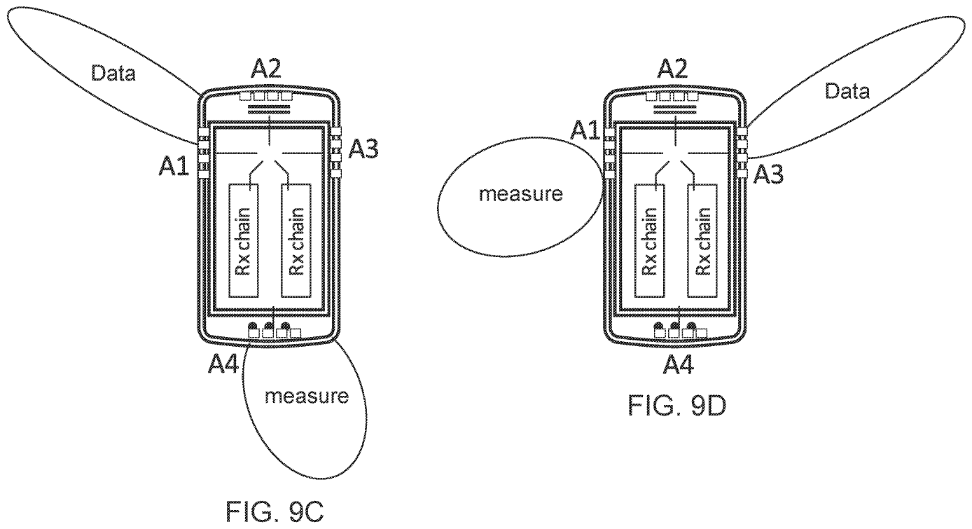

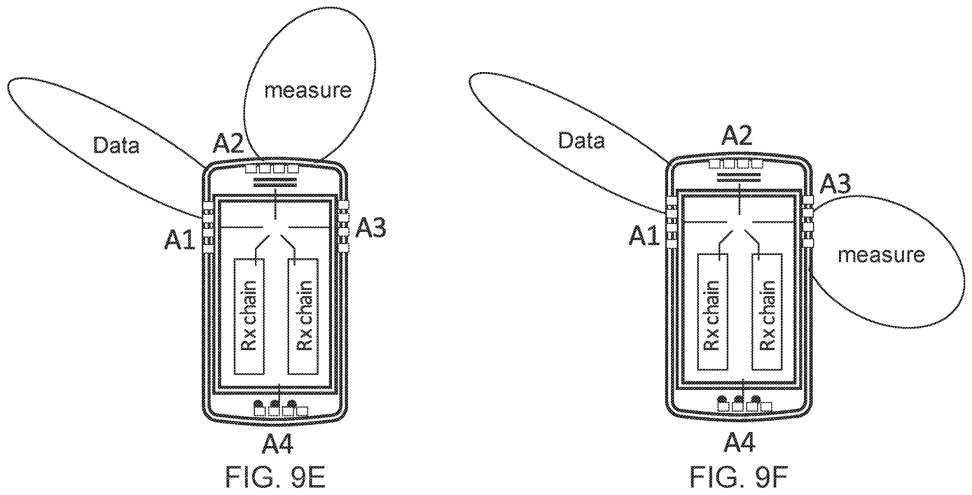

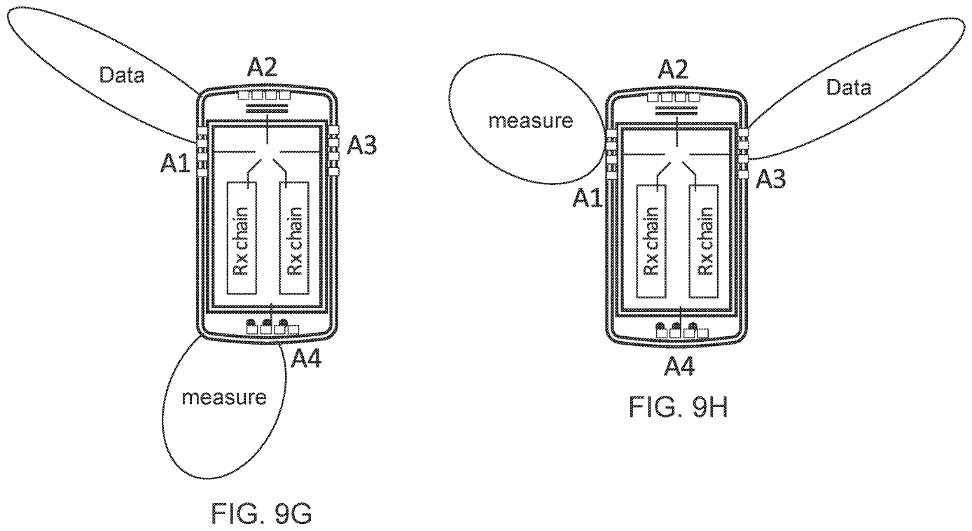

FIGS. 9A-H depict example embodiments of using Rx chains for various SMTC occasions. Specifically, it is assumed that the TCI state related to the data beam in panel A1 has a higher SNR than the SNR experienced on data beams on panel A3, and a 25/75% SMTC sharing factor among the RX chains is associated with that UE. In this case, the UE may use one panel or Rx chain for RRM measurements, and may use one panel or Rx chain for data reception. The first Rx chain (on panel A1) may be used for data in FIGS. 9A-C and E-G, while the second Rx chain (associated with panel A3) may perform RRM measurements using panels A2, A3, and A4. Similarly, in FIGS. 9D and 9H, only the Rx chain associated with the TCI state related to the refined beam (used for data transmission/reception) in the panel A1 may have scheduling restrictions, while the UE may perform RRM measurements using panel A1.

In general, FIGS. 9A-H illustrate when scheduling restrictions due to RRM measurement occur during an SMTC occasion. The “data” labels shown on each of the panels indicate that the UE may receive data without scheduling restrictions even when an SMTC occurs. The “measure” labels indicate that the UE may use that panel to perform measurements, and that scheduling restrictions can be expected (if that panel is used for data scheduling). If there is neither “data” nor “measure” on a panel during the SMTC, if a panel is used for data scheduling (e.g., panel A3 in FIG. 9C), scheduling restrictions may be expected since the UE may use the Rx chain associated with panel A3 to perform measurements (using A4). As a result, the UE may not transmit/receive data, and scheduling restrictions may occur.

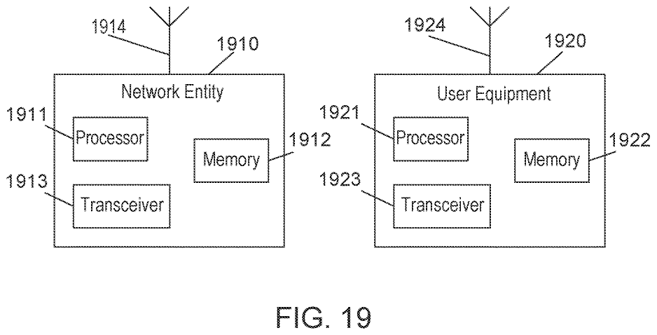

FIG. 10 illustrates an example of a signaling diagram for activation of sharing factors based on measurement reports. Serving cell 1020 and multi-Rx UE 1030 may be similar to NE 1910 and UE 1920, as illustrated in FIG. 19, according to certain example embodiments. UE 1030 may include multiple receivers, shown as Rx1 and Rx2.

At 1001, Rx1 and Rx2 of UE 1030 may enter an initial state with higher SNR/RSRP in TCI #1 than TCI #2.

At 1002, Rx2 of UE 1030 may transmit a measurement report to serving cell 1020, which may include reference signals related to TCI #1 and reference signals related to TCI #2.

At 1003, serving cell 1020 and UE 1030 may apply a configuration for TCI #1 and TCI #2.

At 1004, serving cell 1020 may transmit to UE 1030 multiple Rx DL scheduling configurations, such as SNR or RSRP thresholds between each sharing mode (e.g., TCI_share_threshold1, TCI_share_threshold2, etc.).

In certain example embodiments, at 1005, UE 1030 may transmit to serving cell 1020 an indication of support for a ratio of sharing between TCI #1 and TCI #2, such as 25%/75% sharing, 33%/67% sharing, or 50%/50% sharing.

In response to the measurement report received at 1002 indicating 25%/75% sharing according to the thresholds configured in step 1004, at 1006, 25%/75% sharing between TCI #1 and TCI #2 may be implicitly activated. At 1007, UE 1030 may move, wherein SNR/RSRP may shift such that SNR/RSRP in TCI #2 is now larger than in TCI #1. At 1008, UE 1030 may transmit a measurement report to serving cell 1020 indicating that SNR/RSRP is higher with TCI #2 than TCI #1.

In some example embodiments, at 1009, in response to a measurement report received at 1008 with levels for TCI #1 and TCI #2 indicating 75%/25% sharing according to the thresholds configured in step 1004, 75%/25% sharing between TCI #1 and TCI #2 may be activated implicitly. At 1010, UE 1030 may move, wherein SNR/RSRP may be equal on both TCI #1 and TCI #2. At 1011, UE 1030 may transmit a measurement report to serving cell 1020 indicating that SNR/RSRP is equal on both TCI #1 and TCI #2.

In various example embodiments, at 1012, in response to a measurement report at 1011 with levels for TCI #1 and TCI #2 indicating 50%/50% sharing according to the thresholds configured in step 1004, 50%/50% sharing between TCI #1 and TCI #2 may be implicitly activated.

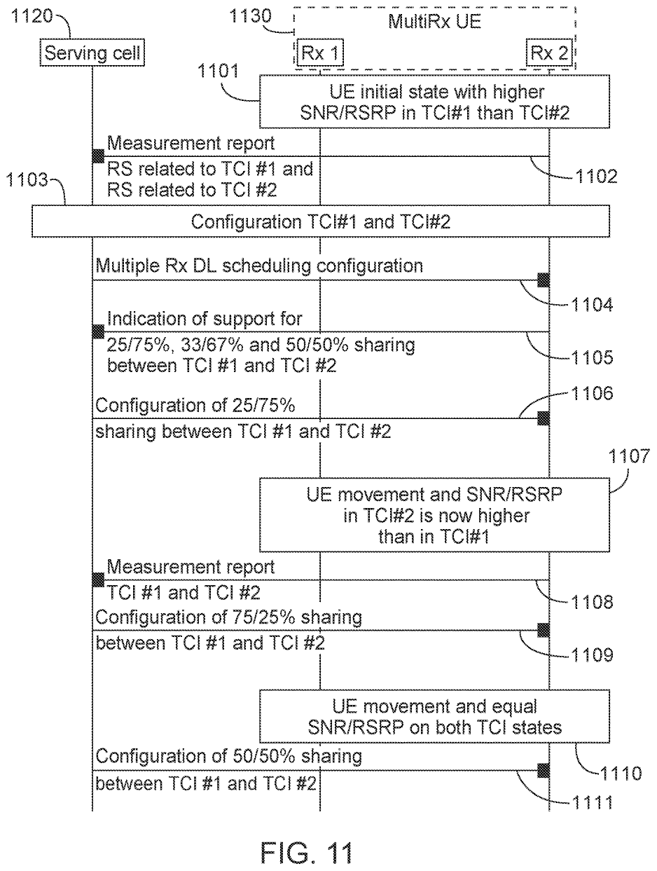

FIG. 11 illustrates another example of a signaling diagram for base station-triggered configuration of SMTC sharing between TCI states. Serving cell 1120 and multi-Rx UE 1130 may be similar to NE 1910 and UE 1920, as illustrated in FIG. 19, according to certain example embodiments. UE 1130 may include multiple receivers, shown as Rx1 and Rx2.

At 1101, UE 1130 may enter an initial state with a higher SNR/RSRP in TCI #1 than in TCI #2.

At 1102, UE 1130 may transmit a measurement report to serving cell 1120, which may include reference signals related to TCI #1 and/or reference signals related to TCI #2.

At 1103, serving cell 1120 and UE 1130 may configure TCI #1 and TCI #2.

At 1104, serving cell 1120 may transmit to UE 1130 multiple Rx DL scheduling configurations.

At 1105, UE 1130 may transmit to serving cell 1120 an indication of support for a ratio of sharing between TCI #1 and TCI #2, such as 25%/75% sharing, 33%/67% sharing, or 50%/50% sharing.

At 1106, serving cell 1120 may transmit to UE 1130 a configuration of 25%/75% sharing between TCI #1 and TCI #2. Serving cell 1120 may use the measurement reports received at 1102 and/or other data to determine the best sharing ratio.

At 1107, UE 1130 may move, and SNR/RSRP in TCI #2 may become larger than SNR/RSRP in TCI #1.

At 1108, UE 1130 may transmit to serving cell 1120 a measurement report of TCI #1 and TCI #2.

At 1109, serving cell 1120 may transmit to UE 1130 another configuration of 75%/25% sharing between TCI #1 and TCI #2. Serving cell 1120 may again use the measurement report received at 1108 and/or other statistics to determine the best sharing factor.

At 1110, UE 1130 may continue moving, and SNR/RSRP may be equal for both TCI #1 and TCI #2.

At 1111, serving cell 1120 may transmit to UE 1130 a configuration of 50%/50% ratio sharing between TCI #1 and TCI #2. Serving cell 1120 may use measurement reports and/or other statistics to determine the best sharing factor.

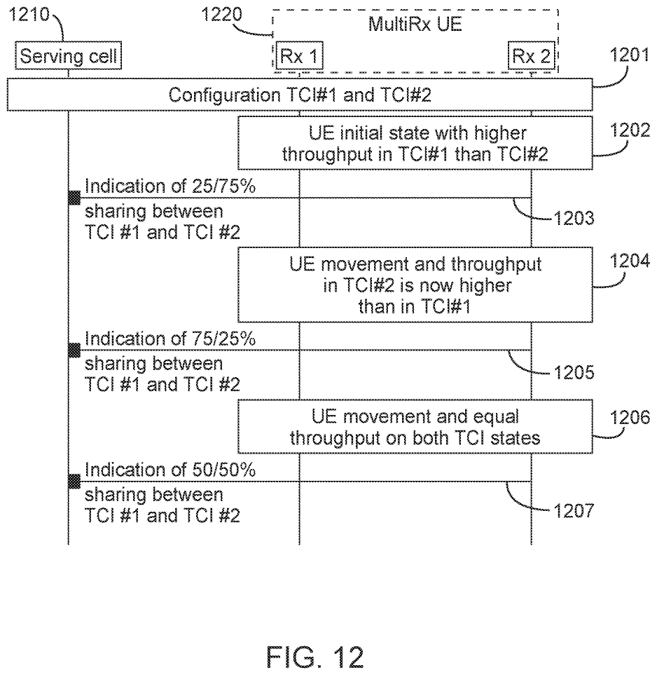

FIG. 12 illustrates an example of a signaling diagram depicting for UE-triggered configuration of SMTC sharing between TCI states. Serving cell 1210 and multi-Rx UE 1220 may be similar to NE 1910 and UE 1920, as illustrated in FIG. 19, according to certain example embodiments. UE 1220 may include multiple receivers, shown as Rx1 and Rx2.

At 1201, serving cell 1210 and UE 1220 may apply a configuration of TCI #1 and TCI #2.

At 1202, UE 1220 may enter an initial state with more throughput in TCI #1 than TCI #2. In response, at 1203, UE 1220 may transmit to serving cell 1210 an indication of, for example, 25%/75% sharing between TCI #1 and TCI #2.

At 1204, UE 1220 may move, and throughput in TCI #2 may be more than TCI #1. In response, at 1205, UE 1220 may transmit to serving cell 1210 an indication of, for example, 75%/25%, sharing between TCI #1 and TCI #2.

At 1206, UE 1220 may move, and throughput in TCI #1 and TCI #2 may be equal. In response, at 1207, UE 1220 may transmit to serving cell 1210 an indication of 50%/50% sharing between TCI #1 and TCI #2.

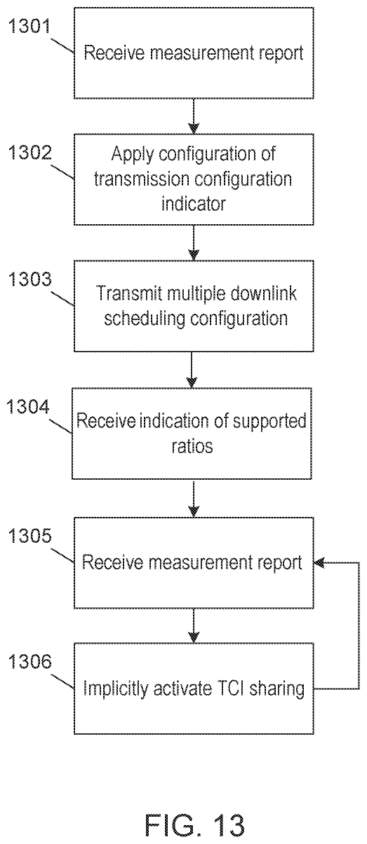

FIG. 13 illustrates an example of a flow diagram of a method for activation of sharing factors based on measurement reports that may be performed by a NE, such as NE 1910 illustrated in FIG. 19, according to various example embodiments.

At 1301, the method may include receiving a measurement report from a UE, such as NE 1910 illustrated in FIG. 19, which may include reference signals related to TCI #1 and/or reference signals related to TCI #2.

At 1302, the method may include applying a configuration for TCI #1 and TCI #2.

At 1303, the method may include transmitting to the UE multiple Rx DL scheduling configurations, such as SNR or RSRP thresholds between each sharing mode (e.g., TCI_share_threshold1, TCI_share_threshold2, etc.).

In certain example embodiments, at 1304, the method may include receiving from the UE an indication of support for a ratio of sharing between TCI #1 and TCI #2, such as 25%/75% sharing, 33%/67% sharing, or 50%/50% sharing.

At 1305, a measurement report may be received. In response to the measurement report received at 1305, at 1306, the method may calculate the sharing between TCI #1 and TCI #2, which is implicitly activated based on the configuration on 1303. After step 1306, the method may loop back to 1305 once another new measurement report is received.

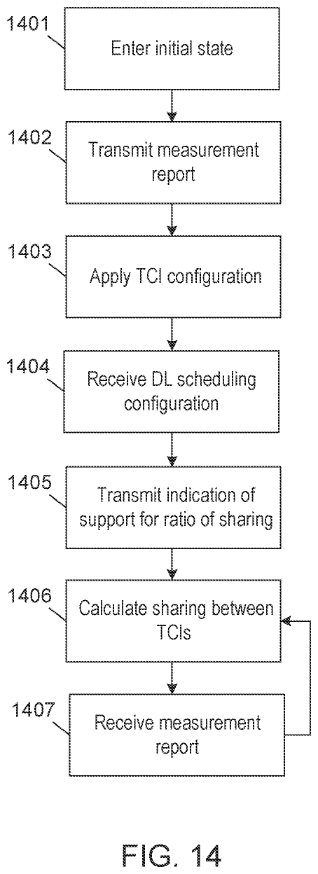

FIG. 14 illustrates an example of a flow diagram of a method for activation of sharing factors based on measurement reports that may be performed by a UE, such as UE 1920 illustrated in FIG. 19, according to various example embodiments. At 1401, the method may include entering an initial state with a larger SNR/RSRP in TCI #1 than in TCI #2.

At 1402, the method may include transmitting, to a NE such as 1910 illustrated in FIG. 19, a measurement report, which may include reference signals related to TCI #1 and/or reference signals related to TCI #2.

At 1403, the method may include applying a configuration for TCI #1 and TCI #2.

At 1404, the method may include receiving from the NE multiple Rx DL scheduling configurations, such as SNR or RSRP thresholds between each sharing mode (e.g., TCI_share_threshold1, TCI_share_threshold2, etc.).

In certain example embodiments, at 1405, the method may include transmitting to the NE an indication of support for a ratio of sharing between TCI #1 and TCI #2, such as 25%/75% sharing, 33%/67% sharing, or 50%/50% sharing.

In response to the measurement report received at 1402, and the indicated support for ratio of sharing in 1405, at 1406, the method may calculate the sharing between TCI #1 and TCI #2, which may be implicitly activated based on the configuration on 1403.

At 1407, the method may include receiving another measurement report, and repeating the procedure at 1406. The method may include calculating the sharing factor based upon the rules at 1403, and activating the sharing factor.

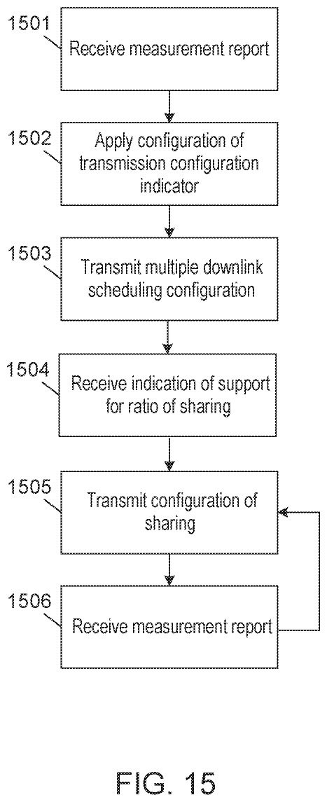

FIG. 15 illustrates an example of a flow diagram of a method for base station-triggered configuration of SMTC sharing between TCI states that may be performed by a NE, such as NE 1910 illustrated in FIG. 19, according to various example embodiments.

At 1501, the method may include receiving a measurement report from a UE, such as UE 1920 illustrated in FIG. 19, which may include reference signals related to TCI #1 and/or reference signals related to TCI #2.

At 1502, the method may include configuring TCI #1 and TCI #2.

At 1503, the method may include transmitting to the UE multiple Rx DL scheduling configurations.

At 1504, the method may include receiving an indication of support for a ratio of sharing between TCI #1 and TCI #2, such as 25%/75% sharing, 33%/67% sharing, or 50%/50% sharing.

At 1505, the method may include transmit to the UE a configuration of a sharing factor between TCI #1 and TCI #2, such as 25%/75% sharing. The NE may use the measurement reports received at 1501 and/or other data to determine the best sharing ratio.

At 1506, the method may include receiving from the UE a measurement report of TCI #1 and TCI #2. Based on the measurement report of 1506, the method may return to 1505, where the method may include transmitting to the UE a configuration of a sharing between TCI #1 and TCI #2, such as 75%/25% sharing.

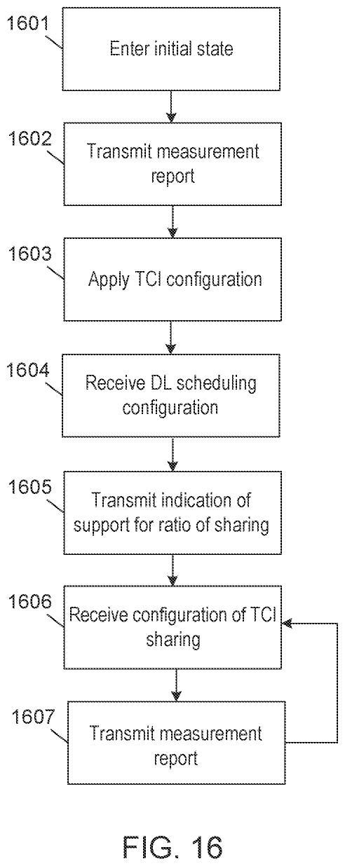

FIG. 16 illustrates an example of a flow diagram of a method for base station-triggered configuration of SMTC sharing between TCI states that may be performed by a UE, such as UE 1920 illustrated in FIG. 19, according to various example embodiments.

At 1601, the method may include entering an initial state with a larger SNR/RSRP in TCI #1 than TCI #2.

At 1602, the method may include transmitting a measurement report to a NE, such as NE 1910 illustrated in FIG. 19, which may include reference signals related to TCI #1 and/or reference signals related to TCI #2.

At 1603, the method may include configuring TCI #1 and TCI #2.

At 1604, the method may include receiving from the NE multiple Rx DL scheduling configurations.

At 1605, the method may include transmitting to the NE an indication of support for a ratio of sharing between TCI #1 and TCI #2, such as 25%/75% sharing, 33%/67% sharing, or 50%/50% sharing.

At 1606, the method may include receiving from the NE a configuration of a sharing factor between TCI #1 and TCI #2, such as 25%/75% sharing. The measurement reports transmitted at 1602 and/or other data may be used to determine the best sharing ratio.

At 1607, the method may include transmitting to the NE a measurement report of TCI #1 and TCI #2. Based on the measurement report of 1607, the method may return to 1606, where the method may include receiving, from the NE, a configuration of a sharing between TCI #1 and TCI #2, such as 75%/25% sharing. The measurement reports transmitted at 1608 and/or other data may be used to determine the best sharing ratio.

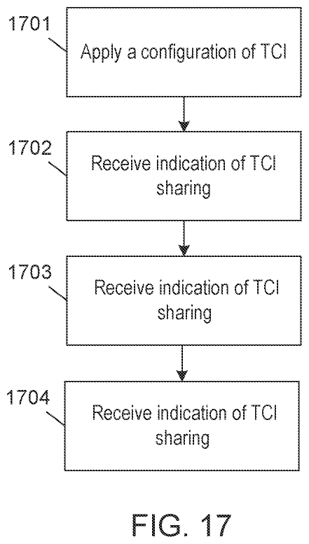

FIG. 17 illustrates an example of a flow diagram of a method for UE-triggered configuration of SMTC sharing between TCI states that may be performed by a NE, such as NE 1910 illustrated in FIG. 19, according to various example embodiments.

At 1701, the method may include applying a configuration of TCI #1 and TCI #2.

At 1702, the method may include receiving from a UE, such as UE 1920 illustrated in FIG. 19, an indication of, for example, 25%/75% sharing between TCI #1 and TCI #2, with more throughput in TCI #1 than TCI #2.

At 1703, the method may include receiving from the UE an indication of, for example, 75%/25%, sharing between TCI #1 and TCI #2, with throughput in TCI #2 more than TCI #1.

At 1704, the method may include receiving from the UE an indication of 50%/50% sharing between TCI #1 and TCI #2, wherein throughput in TCI #1 and TCI #2 may be equal.

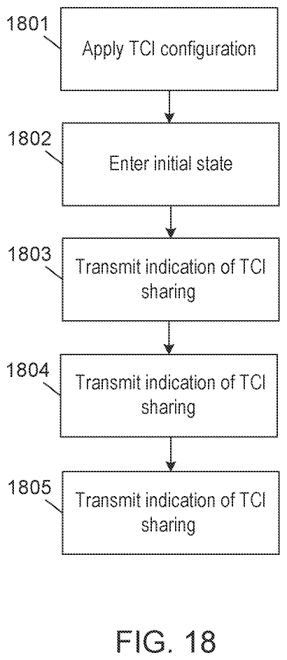

FIG. 18 illustrates an example of a flow diagram of a method for UE-triggered configuration of SMTC sharing between TCI states that may be performed by a UE, such as UE 1920 illustrated in FIG. 19, according to various example embodiments.

At 1801, the method may include applying a configuration of TCI #1 and TCI #2.

At 1802, the method may include entering an initial state, for example, with more throughput in TCI #1 than TCI #2. In response, at 1803, the method may include transmitting to a NE, such as NE 1910 illustrated in FIG. 19, an indication of a sharing factor between TCI #1 and TCI #2, for example, 25%/75% sharing between TCI #1 and TCI #2.

At 1804, the method may include transmitting to the NE an indication of the sharing between TCI #1 and TCI #2, for example, 75%/25% sharing between TCI #1 and TCI #2. For example, the update may be needed if the device moves, and throughput of one TCI may become higher than the other TCI.

FIG. 19 illustrates an example of a system according to certain example embodiments. In one example embodiment, a system may include multiple devices, such as, for example, NE 1910 and/or UE 1920.

NE 1910 may be one or more of a base station (e.g., 3G UMTS NodeB, 4G LTE Evolved NodeB, or 5G NR Next Generation NodeB), a serving gateway, a server, and/or any other access node or combination thereof.

NE 1910 may further comprise at least one gNB-centralized unit (CU), which may be associated with at least one gNB-distributed unit (DU). The at least one gNB-CU and the at least one gNB-DU may be in communication via at least one F1 interface, at least one Xₙ-C interface, and/or at least one NG interface via a 5^{th} generation core (5GC).

UE 1920 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 1910 and/or UE 1920 may be one or more of a citizens broadband radio service device (CBSD).

NE 1910 and/or UE 1920 may include at least one processor, respectively indicated as 1911 and 1921. Processors 1911 and 1921 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 1912 and 1922. The memory may be fixed or removable. The memory may include computer program instructions or computer code contained therein. Memories 1912 and 1922 may independently be any suitable storage device, such as a non-transitory computer-readable medium. The term “non-transitory,” as used herein, may correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 1911 and 1921, memories 1912 and 1922, and any subset thereof, may be configured to provide means corresponding to the various blocks of FIGS. 10-18. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 19, transceivers 1913 and 1923 may be provided, and one or more devices may also include at least one antenna, respectively illustrated as 1914 and 1924. The device may have many antennas, such as an array of antennas configured for MIMO communications, or multiple antennas for multiple RATs. Other configurations of these devices, for example, may be provided. Transceivers 1913 and 1923 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 10-18). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 10-18. As used in this application, the term “circuitry” may refer to one or more or all of the following: (a) hardware-only circuit implementations (such as implementations in only analog and/or digital circuitry), (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

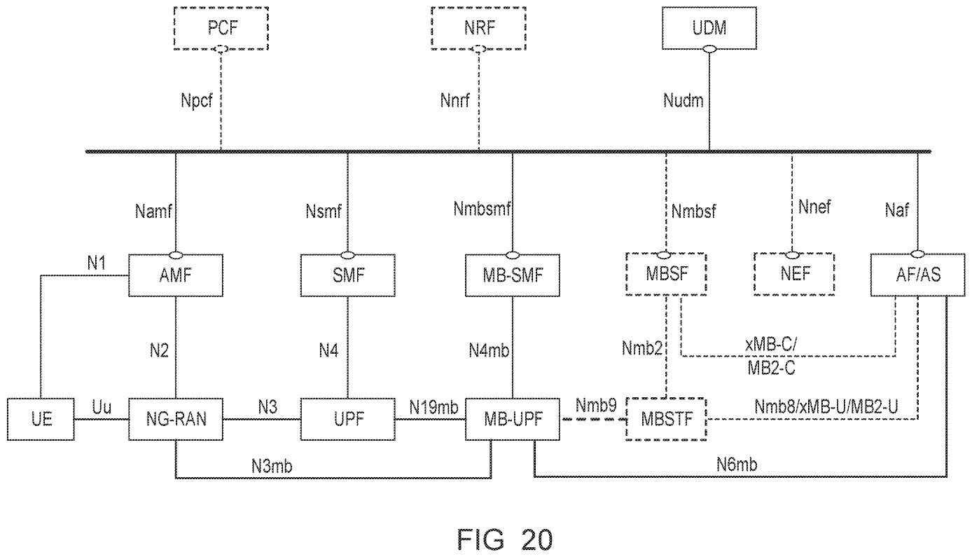

FIG. 20 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 20 may be similar to NE 1910 and UE 1920, respectively. The user plane function (UPF) may provide services such as intra-RAT and inter-RAT mobility, routing and forwarding of data packets, inspection of packets, user plane quality of service (QoS) processing, buffering of downlink packets, and/or triggering of downlink data notifications. The application function (AF) may primarily interface with the core network to facilitate application usage of traffic routing and interact with the policy framework.

According to certain example embodiments, processors 1911 and 1921, and memories 1912 and 1922, may be included in or may form a part of processing circuitry or control circuitry. In addition, in some example embodiments, transceivers 1913 and 1923 may be included in or may form a part of transceiving circuitry.

In some example embodiments, an apparatus (e.g., NE 1910 and/or UE 1920) may include means for performing a method, a process, or any of the variants discussed herein. Examples of the means may include one or more processors, memory, controllers, transmitters, receivers, and/or computer program code for causing the performance of the operations.

In various example embodiments, apparatus 1920 may be controlled by memory 1922 and processor 1921 to transmit, to a network entity, a measurement timing configuration; and receive a sharing factor associated with the measurement timing configuration. The sharing factor may indicate a sharing pattern associated with a first receive element performing radio resource management measurements, and a second receive element configured to receive data without scheduling restrictions.

Certain example embodiments may be directed to an apparatus that includes means for performing any of the methods described herein including, for example, means for transmitting, to a network entity, a measurement timing configuration; and means for receiving a sharing factor associated with the measurement timing configuration. The sharing factor may indicate a sharing pattern associated with a first receive element performing radio resource management measurements, and a second receive element configured to receive data without scheduling restrictions.

In various example embodiments, apparatus 1910 may be controlled by memory 1912 and processor 1911 to transmit, to a user equipment, a measurement timing configuration; and transmit a sharing factor associated with the measurement timing configuration. The sharing factor may indicate a sharing pattern associated with a first receive element performing radio resource management measurements, and a second receive element configured to receive data without scheduling restrictions.

Certain example embodiments may be directed to an apparatus that includes means for performing any of the methods described herein including, for example, means for transmitting, to a user equipment, a measurement timing configuration; and means for transmitting a sharing factor associated with the measurement timing configuration. The sharing factor may indicate a sharing pattern associated with a first receive element performing radio resource management measurements, and a second receive element configured to receive data without scheduling restrictions.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### PARTIAL GLOSSARY

3GPP 3^{rd} Generation Partnership Project
5G 5^{th} Generation
5GC 5^{th} Generation Core
6G 6^{th} Generation
AF Application Function
ASIC Application Specific Integrated Circuit
CBSD Citizens Broadband Radio Service Device
CE Control Element
CPU Central Processing Unit
CSI Channel State Information
CU Centralized Unit
DL Downlink
DU Distributed Unit
eMBB Enhanced Mobile Broadband
eNB Evolved Node B
FR Frequency Range
gNB Next Generation Node B
GPS Global Positioning System
HDD Hard Disk Drive
IoT Internet of Things
L1 Layer 1
L3 Layer 3
LTE Long-Term Evolution
LTE-A Long-Term Evolution Advanced
MAC Medium Access Control
MEMS Micro Electrical Mechanical System
MIMO Multiple Input Multiple Output
mMTC Massive Machine Type Communication
NE Network Entity
NG Next Generation
NG-eNB Next Generation Evolved Node B
NG-RAN Next Generation Radio Access Network
NR New Radio
PDA Personal Digital Assistance
PDSCH Physical Downlink Shared Channel
QoS Quality of Service
RAM Random Access Memory
RAN Radio Access Network
RAT Radio Access Technology
RF Radio Frequency
ROM Read-Only Memory
RRC Radio Resource Control
RRH Remote Radio Head
RRM Radio Resource Management
RSRP Reference Signal Received Power
SCS Subcarrier Spacing
SFN System Frame Number
SMTC Synchronization Signal Physical Broadcast Channel Block Measurement Timing Configuration
SNR Signal-to-Noise Ratio
SSB Synchronization Signal Block
TCI Transmission Configuration Indicator
TRP Transmission Reception Point
UE User Equipment
UMTS Universal Mobile Telecommunications System
UPF User Plane Function
URLLC Ultra-Reliable and Low-Latency Communication
UTRAN Universal Mobile Telecommunications System Terrestrial Radio Access Network

1-66. (canceled)

67. An apparatus comprising:
at least one processor; and
at least one memory storing instructions that, when executed by the at least one processor, cause the apparatus at least to:
transmit, to a network entity, at least one indication corresponding to at least one supported sharing ratio; and
receive, in response to the transmission, a sharing factor associated with a measurement timing configuration,
wherein the sharing factor indicates a sharing pattern associated with a first receive element performing radio resource management measurements, and a second receive element configured to receive data without scheduling restrictions.

68. The apparatus of claim 67, wherein the first receive element is subject to scheduling restrictions.

69. The apparatus of claim 67, wherein the at least one memory and the instructions, when executed by the at least one processor, further cause the apparatus at least to:
receive, from the network entity, a multiple receiver downlink scheduling configuration comprising at least one threshold associated with at least one sharing mode.

70. The apparatus of claim 69, wherein the at least one threshold comprises at least one of a signal-to-noise ratio threshold or reference signal received power threshold.

71. The apparatus of claim 67, wherein the sharing factor was selected based on the at least one supported sharing ratio.

72. The apparatus of claim 67, wherein the first receive element is associated with a first transmission configuration indication (TCI) and the second receive element is associated with a second TCI.

73. The apparatus of claim 67, wherein the at least one memory and the instructions, when executed by the at least one processor, further cause the apparatus at least to:
transmit, to the network entity, a measurement report indicating at least one metric associated with the first receive element and at least one metric associated with the second receive element.

74. The apparatus of claim 73, wherein the at least one metric comprises a reference signal.

75. The apparatus of claim 73, wherein the at least one memory and the instructions, when executed by the at least one processor, further cause the apparatus at least to:
activate, based on the measurement report, a sharing ratio between the first receive element and the second receive element.

76. The apparatus of claim 75, wherein a larger measurement metric of the first receive element and the second receive element has larger share of the sharing ratio.

77. The apparatus of claim 67, wherein the apparatus comprises or is comprised in a user equipment.

78. An apparatus comprising:
at least one processor; and
at least one memory storing instructions that, when executed by the at least one processor, cause the apparatus at least to:
receive, from a user equipment, at least one indication corresponding to at least one supported sharing ratio; and
transmit, in response to the reception, a sharing factor associated with a measurement timing configuration,
wherein the sharing factor indicates a sharing pattern associated with a first receive element of the user equipment performing radio resource management measurements, and a second receive element of the user equipment configured to receive data without scheduling restrictions.

79. The apparatus of claim 78, wherein the first receive element is subject to scheduling restrictions.

80. The apparatus of claim 78, wherein the at least one memory and the instructions, when executed by the at least one processor, further cause the apparatus at least to:
transmit, to the user equipment, a multiple receiver downlink scheduling configuration comprising at least one threshold associated with at least one sharing mode.

81. The apparatus of claim 80, wherein the at least one threshold comprises at least one of a signal-to-noise ratio threshold or reference signal received power threshold.

82. The apparatus of claim 78, wherein the first receive element is associated with a first transmission configuration indication (TCI) and the second receive element is associated with a second TCI.

83. The apparatus of claim 78, wherein the at least one memory and the instructions, when executed by the at least one processor, further cause the apparatus at least to:
receive, from the user equipment, a measurement report indicating at least one metric associated with the first receive element and at least one metric associated with the second receive element.

84. The apparatus of claim 83, wherein the at least one metric comprises a reference signal.

85. The apparatus of claim 83, wherein the at least one memory and the instructions, when executed by the at least one processor, further cause the apparatus at least to:
activate, based on the measurement report, a sharing ratio between the first receive element and the second receive element.

86. A method comprising:
transmitting, to a network entity, at least one indication corresponding to at least one supported sharing ratio; and
receiving, in response to the transmission, a sharing factor associated with the measurement timing configuration,
wherein the sharing factor indicates a sharing pattern associated with a first receive element performing radio resource management measurements, and a second receive element configured to receive data without scheduling restrictions.
